(19) United States
(12) Patent Application Publication
(10) Pub. No.: US 2008/0032578 A1
(43) Pub. Date: Feb. 7, 2008

(54) SELF-INFLATING RECLINING MAT

(76) Inventor: HARTMUT ORTLIEB, Heilsbronn (DE)

Correspondence Address: LACKENBACH SIEGEL, LLP, LACKENBACH SIEGEL BUILDING, 1 CHASE ROAD, SCARSDALE, NY, 10583, US

(21) Appl. No.: 11/871,432

(22) Filed: Oct. 12, 2007

Related U.S. Application Data
(63) Continuation of application No. 10/519,039, filed on Mar. 23, 2006, now abandoned.

(51) Int. Cl. D03D 15/00; B32B 3/26; D04B 1/14

(52) U.S. Cl. 442/187; 428/304.4; 442/307

(57) ABSTRACT

The invention relates to a self-inflating mat or pillow consisting of open-cell foamed material which is hermetically covered on both sides by outer layers of cloth, the outer layers being sealed on the edges and at least one valve providing a connection between the foamed material and the surrounding atmosphere. At least one layer of cloth or a mesh fabric is provided on at least one side and the cloth or mesh fabric consists of a hot-pressed yarn coated with a thermoplastic material.

### CROSS REFERENCE TO RELATED APPLICATIONS

This application claims priority from PCT/DE2002/002304, filed Jun. 22, 2002, and U.S. Ser. No. 10/519,039 filed Dec. 22, 2004, the contents of which are incorporated herein by reference.

### BACKGROUND OF THE INVENTION

The present invention relates to a self-inflating reclining-mat or cushion of a type which is made of open-cell material airtightly covered on opposite sides with fabric layers, the covering layers being edge welded to each other, one or more valves being employed to connect the foam material with ambient atmosphere.

Mats are known with light weave and pre-coating with solvents of poly urethane and at least two coating layers, as a rule of polyurethane films, the outer coating layer being formed as a lower-melting adhesive system (U.S. Pat. No. 4,624,877). These mats consist of two layers of this coated fabric, between which a light foam material is inwardly adhered, the edges of the coated fabric being welded. This airtight mat is then blown up through a valve. The maximum thickness of the mat is limited by the thickness of the foam, due to the full-surface adhesion. With the valve closed, this mat is very pressure-stable and has good insulating behavior, in spite of a small foam thickness. For this reason it is very light, and hikers and mountain climbers are very pleased to use it. It is very comfortable.

In order for the weld seams withstand high pressure, a pre-coating with solvent has to be applied to the fabric. This pre-coating on the one hand damages the fabric in its strength and on the other hand damages the environment, since solvent is used. The pre-coating is also quite sensitive with regard to UV resistance, so that many mats fail after a period of use. These mats are furthermore often very slippery, since for weight reasons they are often coated on one side only. Since the fabric is relatively slippery on the outside it is then very unsuitable as a place to lie on in downward-sloping places for reclining during camping, Attempts are made to overcome this with synthetic fiber fabrics with cotton structure, but the tendency to slip is thereby only slightly reduced. Furthermore, these fabrics are often not so resistant to puncture, so that on the underside quite smooth, high-strength nylon fabrics are used. However this now and then leads to a banana shape of the mat, since different materials have different expansion behavior. Outside coatings present on one side then also easily take up dirt and water, and are difficult to clean.

### SUMMARY OF THE INVENTION

The present invention has as its object the provision of a self-inflating reclining-mat which overcomes the mentioned prior art mat disadvantages, in that a new fabric, coating and foam connection construction is proposed.

According to the invention, a self-inflating reclining-mat or cushion is of open foam material core layer airtightly covered by outer layers of a fabric on both sides, the outer layers being welded together at the edges and at least one valve being present for connecting the foam material with the ambient atmosphere. On at least one side at least one layer of a woven or knitted fabric comprises a hot-pressed yarn coated with a thermoplastic. The coating of the yarn takes place before weaving. The fabric can then be calendered. The fabric can be coated with one or more foil coatings, the foil coatings having a melting temperature lower than the thermoplastic material and lower than the melting point of the outer layer fabric. Other features are discussed in the description given below.

### DESCRIPTION OF THE DRAWINGS

No drawings are present

### DESCRIPTION OF THE PREFERRED EMBODIMENTS

According to a preferred embodiment of the invention, the fabric is coated with a foil which has a lower melting point than either the thermoplastic plastic and/or the fabric. Optionally, the fabric can be coated with at least two foils with different melting points, an outer foil coating having a lower melting point than an inner foil coating. The foil coating can take place by thermal laminating or by application with a wide slit nozzle.

According to another embodiment of the invention, a coated fabric is woven or knitted with yarns coextruded with thermoplastics and having little or no twist, and pressed flat in an ironing process, so that a thin fabric coated through and through results, providing a dense little coated very thin mass. With light thin yarns, the adhesion of the coating nearly corresponds to the material strength of the coating material, without damaging the fabric with adhesion mediators or solvents. This coated fabric is now coated with no foil, or with at least one or two foils. Here the first coating acts as the airtight layer. The inner acts as the adhesive layer for foam. In a further version of the invention, the ironed and calendered fabric is already airtight, so that it needs only a further, lower-melting adhesive layer.

In a further embodiment of the invention, the ironed and calendered fabric is already airtight, and the coating mass is dimensioned such that this acts as an adhesion layer for the foam. This is possible because the foam cannot with its grid structure press through the fabric during the thermal adhesion process.

The advantage of this mat is that due to the coating of the outer side; the mat obtains a closed or partially closed coating, without substantially increasing the total weight. This coating has on the outer side a good frictional action in relation to the sleeping bag, so that the camper no longer easily slides on downward-sloping ground. The mat cannot take up water, or does not have to be made water-repellent with environmentally damaging fluorocarbon coatings.

The mat can be cleaned very easily, which is not the least of advantages in the medical field. Furthermore, additional element applications can be applied onto the outside of the mat as by adhesion or welding without making the total weight of the mat heavier by a conventional second coating. A lighter fabric can be chosen, since it is not weakened by solvents or adhesion aids. Furthermore, the puncture resistance and folding resistance of the composite, and hence the stability of the mass, are increased. Since fabrics with pre-coatings based on solvents traditionally have a poor tear strength, the stability of the mat is enhanced.

The thermoplastic plastic and the yarn are advantageously made flame-resistant.

Two mats can be joined by a welded-on profile.

The fabric preferably consists of quartz yarn, of Aramid fiber, or of modified polyester such as VEKTRAN®. High strength yarns which are inherently difficult to adhere can be used.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1.-14. (canceled)

15. A self-inflating mat, comprising:
a first foamed material hermetically covered by means of outer layers of cloth;
said outer layers of cloth being sealed on edges thereof;
valve means for adjustably connecting said foamed material to an external atmosphere; and
at least one layer of said cloth including a hot-pressed yarn coated with a thermoplastic material.

16. A self-inflating mat comprising:
a core layer of an open foam material;
outer layers of a fabric covering each of opposite sides of said core layer, edges of said outer layers being airtightly sealed together, at least one of said outer layers comprising a hot-pressed yarn coated with a thermoplastic material; and
a valve connecting said core layer with an ambient environment.

17. A self-inflating mat in accordance with claim 16, wherein:
at least a portion of said fabric covering has been subjected to a calendering.

18. A self-inflating mat in accordance with claim 16, wherein:
said at least one outer layer is one of a woven and a knitted fabric, the yarn of which is coated with said thermoplastic material before any weaving and knitting of said yarn.

19. A self-inflating mat in accordance with claim 16, wherein:
the fabric of said at least one outer layer is coated with a foil; and
said foil having a lower melting point than the thermoplastic material, and a lower melting point than the fabric of said one outer layer.

20. A self-inflating mat in accordance with claim 19, further comprising:
a second foil coating on said one outer layer overlaying the first-mentioned foil coating, said second foil coating and the first-mentioned foil coating having different melting points.

21. A self-inflating mat in accordance with claim 20, wherein:
the second foil coating has a lower melting point than the first-mentioned foil coating.

22. A self-inflating mat in accordance with claim 19, wherein:
the foil coating of said one outer layer fabric is applied by one of a thermal laminating and a wide slit nozzle application.

23. A self-inflating mat in accordance with claim 20, wherein:
the first foil coating and the second foil coating of said one outer layer fabric is applied by one of a thermal laminating and a wide slit nozzle application.

24. A self-inflating mat in accordance with claim 16, wherein:
the thermoplastic material and the yarn are flame resistant.

25. A self-inflating mat in accordance with claim 16, wherein:
additional element applications are applied to a mat outside surface by one of adhesion and welding.

26. A self-inflating mat in accordance with claim 16, wherein:
said fabric covering comprises quartz yarn.

27. A self-inflating mat in accordance with claim 16, wherein:
said fabric covering comprises an Aramid fiber.

28. A self-inflating mat in accordance with claim 16, wherein:
said fabric covering comprises a modified polyester.

29. A self-inflating mat in accordance with claim 28, wherein:
said modified polyester is VEKTRAN.

30. A self-inflating mat in accordance with claim 16, wherein:
said fabric comprises high strength yarns having an inherently poor adhesion property.

31. A Kit, comprising:
at least a first and a second self inflating mat;
each said mat connected by a welded on profile element;
each said mat further comprising:
a core layer of an open foam material;
outer layers of a fabric covering each of opposite sides of said core layer, edges of said outer layers being airtightly sealed together, at least one of said outer layers comprising a hot-pressed yarn coated with a thermoplastic material; and
a valve connecting said core layer with an ambient environment.
